(19) United States
(12) Patent Application Publication
(10) Pub. No.: US 2019/0138635 A1
(43) Pub. Date: May 9, 2019

(54) Methods Data Structures Circuits Devices Systems and Functionally Associated Machine Executable Code for Artificial Intelligence Based Situational Assessment

(71) Applicant: GETALERT LTD., Herzliya (IL)

(72) Inventor: Dor Givon, Tel Aviv (IL)

(21) Appl. No.: 15/803,889

(22) Filed: Nov. 6, 2017

(51) Int. Cl. G06F 17/30; H04L 29/08; H04W 68/00; G06N 3/04; G06F 15/18; H04L 9/08

(52) U.S. Cl. CPC G06F 17/30516; G06F 17/3087; H04L 67/18; H04L 9/0822; G06N 3/04; G06F 15/18; H04W 68/005

(57) ABSTRACT

Disclosed herein are methods, structures, circuits, devices, systems and functionally associated computer executable code for artificial intelligence based situational assessment. According to some embodiments, there may be provided a location specific situational assessment system comprising a sensor interface to receive sensing related data from each of one or more location specific sensors directed towards and acquiring information from a respective coverage area of a specific location.

An agent application deployment controller may, responsive to location specific information embedded within data received from said one or more sensors, select from a pool of agent application templates an agent application template corresponding to the location specific information and may deploy within a processing platform of said system an agent application based on said selected agent application template. Agent application deployment within the processing platform may include establishing connectivity between the agent application being deployed and one or more system resources.

### FIELD OF THE INVENTION

The present invention relates generally to the fields of image processing and artificial intelligence. More specifically, the present invention relates to methods, structures, circuits, devices, systems and functionally associated computer executable code for artificial intelligence based situational assessment.

### BACKGROUND

The present invention is generally related to the fields of location monitoring, computer vision and artificial intelligence. Locations monitoring is based on sensor technologies ranging from basic temperature sensors and microphones all the way to complex thermal imaging and multispectral scene inspection systems. As human attention to aggregated sensor feeds with large amounts of information embedded therein is limited, computer vision systems and other data type monitoring systems have been designed and implemented to detect specific features within these feeds and to either issue an automatic alarm or to bring these features to the attention of a person for further evaluation.

Artificial intelligence (AI, also machine intelligence, MI) is an umbrella term for intelligent behavior by machines, rather than the natural intelligence (NI) of humans and other animals. Al held the promise of supplementing human attention to the tasks related with monitoring scenes and locations, and responding complex events with the scene or location. For the most part, till today, prior art Al failed to detect and perceive events within a context of the event's occurrence. Accordingly, such Al of the prior art fails to respond correctly, within context, to specific detected event.

Therefore, there is a need in the fields of AI, Computer Vision and monitoring for improved methods, structures, circuits, devices, systems and functionally associated computer executable code for artificial intelligence based situational assessment.

### SUMMARY OF INVENTION

The present invention includes methods, structures, circuits, devices, systems and functionally associated computer executable code for artificial intelligence based situational assessment. The present invention includes machine learning features for establish a context, physical and behavioral, within which artificial intelligence elements provide situational assessment. According to embodiments, there may be provided a computer based system adapted to receive data feeds from one or a plurality of sensors, and to generate and or send alerts when an assessed situation either meets a set of predefined situational parameters and or when an assessed situation falls outside a range or set of situational parameters.

According to embodiments of the present invention, the computer based system may include or be otherwise functionally associated with one or more sensor interfaces to receive sensor output data feeds from one or more sensing devices directed towards a location or coverage area within which the system is operating or towards which the system is directed. Received sensor data feeds may be indicative of an environmental condition within a respective coverage area, entities present in the area and/or events occurring at the location. Artificial intelligence based assessment may be performed by each of a set of agent applications running on a computing platform of the computer based system and based on data received from the one or more sensing devices placed within or otherwise directed towards one or more physical locations which may be referred to as coverage areas of the system.

A combination of one or more agent applications running on a processing platform according to embodiments of the present invention may be referred to as a situational assessment processing platform or system, and it may be configured to process and analyze output data from one or more sensors directed towards the same or different coverage areas of a location for which situation assessment is to be provided. The system may be adapted to generate an alert upon assessment of an alert condition in the location, wherein an alert condition is assessed when processing of the sensor indicates violation of a generic rule or when processing of the sensor data indicates a violation of a dynamically established location specific rule.

According to some embodiments of the present invention, there may be provided a situational assessment system including a digital data processing platform integral or otherwise functionally associated with one or more interfaces to receive one or more data feeds from one or more sensors, such as image sensors (e.g. cameras), motion sensors, acoustic sensors (e.g. microphones), temperature sensors, pressure sensors, etc. The data processing platform may be unified or may be networked and distributed in nature with multiple processing nodes. The one or more sensors may be focused on one or more areas (coverage area) within a location or a scene being monitored or covered by the situational assessment system. Some of the sensors may also act as processing nodes and may include some preprocessing capacity, for example within control circuits integral or otherwise functionally associated with the sensors.

A digital processing platform according to embodiments may include computing units at or near a location being covered and/or computing units operating at a remote location communicatively coupled to sensors at or near a covered location, for example through the internet. One or more computing units may run upon or include dedicated computing hardware located at or in proximity to a location being covered, while other computing units according to embodiments of the present invention, may be computing units instanced and running on one or more virtual servers and/or within containers, such as those common in cloud based architectures. Collaborative sensor data processing by two or more computing units, located locally, located remotely or some combination of the two, may provide processing or computational resources for situational assessment systems for a given covered location or for a given set of covered locations, according to embodiments of the present invention.

According to some embodiments of the present invention, each of one or more computing units may host situational assessments agent applications, wherein at least of two of the situational assessment agent applications may be of a different agent type. A system according to embodiments of the present invention may deploy and/or otherwise run, on computing units of a functionally associated digital processing platform, a set of situational assessment agent applications, each of which applications may be of a different agent type and performing a different function. A system according to embodiments of the present invention may be integral or otherwise functionally associated with a controller adapted to deploy, instance, configure and/or otherwise manage operation of one or more situational assessment agent applications.

A situational assessment system according to further embodiments may include or be functionally associated with one or more location specific data stores, wherein some data stores may include location specific logs or historic data and other data stores may include location specific patterns or prediction data. One or more system agent applications may have access, read and/or right access, to the one or more data stores. Some data stores may include fixed data which can only be read by one or more agent applications. Some data stores may only be written to, that is write accessed, by an agent application of a first agent type and read by, read accessed, by an agent application of a second agent type.

A given situational assessment system covering a specific location or set of locations, according to embodiments of the present invention, may utilize one or more agent applications or processes, each with differing functions, running on a data processing or computational platform. Each of the agent applications or processes (herein after collectively referred to as “agent applications”) may be individually deployed, activated and or configured within a given situational assessment system for a given covered location or set of covered locations, by an agent deployment controller. A deployment controller according to embodiments of the present invention may deploy each of one more agent applications as an instances of an agent application template selected from a pool of agent application templates, wherein each agent application template in the pool may be for a different agent type, such as, for example: (a) an audio stream feature extractor agent template may be used to instance an agent application of an audio stream feature extraction type, otherwise referable to as an audio stream feature extraction agent application; (b) a video stream feature extractor agent template may be used to instance an agent application of a video stream feature extraction type, otherwise referable to as a video stream feature extraction agent application; (c) an entity characterization agent template may be used to instance an agent application of an entity characterization type, otherwise referable to as an entity characterization agent application; (d) an entity identification agent template may be used to instance an agent application of an entity identification type, otherwise referable to as an entity identification agent application; (e) an entity activity characterization agent template may be used to instance an agent application of an entity activity characterization type, otherwise referable to as an entity activity characterization agent application; (f) an event characterizer agent template may be used to instance an agent application of an event characterization type, otherwise referable to as an event characterization agent application; (g) a personality trait recognition template may be used to instance an agent application of a personality attribute recognition type, otherwise referable to as a personality trait recognition agent application; and etc.

Deployment of an agent application of a given type within a given situational assessment system in accordance with embodiments of the present invention may include configuration and execution, on a portion of a processing platform, of an instance of an agent application template of the given type. Configuration and deployment of an instance of an agent application of a particular type to cover a specific coverage area may include: (a) template selection, (b) processing platform segment selection, (c) computing and other system resource allocation, (e) sensor feed routing, (f) sensor feed encryption key distribution, and (g) establishment of secure interconnectivity between the agent to be deployed and either concurrently or previously deployed agent applications, system controllers, system data stores and other system resources of the given assessment system.

According to embodiments of the present invention, an agent application template pool may include more than one template of a given kind or type, to perform a specific function or set of related functions. For example, a system according to embodiments may include or be otherwise functionally associated with a pool of agent templates including several video image feature extraction type templates, wherein each of the more than one templates of this type may be suited for deferring environments or conditions as might be found within deferring intended coverage areas. Whereas, a first template of the feature extraction type may be preconfigured for instancing agent applications which can cold start, operate and iteratively machine-learning optimize operation within a private indoor coverage area, a second template of this type may be preconfigured for instancing agent applications suited for cold start operation and operational optimization within a public outdoor coverage area.

Agent applications running on the same system and having similar functions, irrespective of being based on the same or different templates, may share operational optimization data, such as for example data indicative of an appearance of an entity or person within physically related coverage areas during a specific range of times, either directly through a secure data link or through a mutually accessible data store. Agent applications running on the same system and having different but related functions, based on the different templates, may share operational data, such as for example data indicative of one or more attributes or characteristic an entity and/or person appearing within the same or within (physically) related coverage areas, either directly through a secure data link or through a mutually accessible data store.

Different types of agent applications, based on different agent templates and performing different tasks, may have different dependencies and may thus require different levels of access to different system resources, including feeds, data stores and other agent application input/outputs. For example, some agent applications, such as a video feed feature extraction agent, based on a video feed feature extractor template, may be executed on a portion of a respective processing platform with access to the relevant video feed(s) from an intended coverage area or location for that agent. Other agent applications, performing the same or a different function in connection with a different coverage area may not have access to the same video feeds, but may be granted access to different video feeds and or other system resources. Both video feed feature extraction agents may have write access to one or more data stores for storing data related to detected features.

As part of the deployment, the video feature extraction agent may be provided or otherwise configured with one or more encryption/decryption credentials required to access the relevant video feed(s). Although, the video feed extraction agent of this example may be paired or otherwise associated with one or more other agent applications running on the system, for example, with an audio feature extraction agent application receiving and analyzing audio feed(s) corresponding to the video feeds received by the video feature extraction agent application, proper deployment of the video feature extraction agent may require only video feed and computing resources access. While for some agent application access to relevant sensor feeds and computing resources may be the only deployment requirements, other applications may require read and/or right access to data stores and access to inputs and/or outputs from other agents. For example, according to embodiments where video and/or audio feature extraction agents are intended to log video/audio feature extraction results, write access to a respective system data stores may also be required.

Certain agent application types, according to embodiments of the present invention, may have dependencies on already deployed agent applications or on other system resources such as data stores. An entity identification agent application, for example, may require interconnection, directly or through a data store, to outputs from a video feed image feature extraction agent. Accordingly, deployment of an entity identification agent application or an entity activity characterization agent may require concurrent or prior deployment of, and interconnection to, a video feed feature extraction agent application for the intended coverage area. Deployment of such agent applications, with dependencies, may also require configuration of read access to certain system data stores and right access to other system data stores.

At least part of the deployment instruction set for a given agent application, in accordance with embodiments of the present invention, may be stored as part of an agent application template based on which the given agent application is installed, executed, deployed and or otherwise instanced. According to further embodiments, the at least partial deployment instruction set for a given agent application type may be stored in a data store or structure functionally associated with the template for the given agent application. Agent applications of differing types have different resource and interconnection requirements for proper operation, and thus their respective templates will include differing deployment instructions to meet the specific deferring needs.

According to embodiments of the present invention, a system deployment controller may deploy a given agent application of a specific type for a specific purpose to cover a specific coverage area, as selected by a system user or system controller, by accessing an agent template corresponding to the given agent application type and applying generic agent deployment instructions associated with the accessed template to the specific pre-existing and/or intended configuration of the system computational platform segment within which the given agent application is to be instanced and or operated. Agent template selection may be explicitly defined by the user or by the controller, or selection may be performed based on a computerized process to correlate an intended use or functional requirement for the to be deployed agent application with a functionality provided by a candidate agent template within a pool of available agent templates. The computerized selection process may also factor specific environmental suitability of different candidate agent templates when selecting between two or more agent templates providing agent applications with similar functionality. For example, although two agent templates may provide for agent applications which function to extract features from audio feeds, one of the templates may be configured to produce agent applications suitable for generic audio feature characterization within audio feeds from all environments, while a second template of the audio feature extraction type may be configured to produce or instance agent applications optimized for audio feature extraction from audio feeds originating specifically from indoor residential coverage areas.

A system according to embodiments of the present invention may include or be otherwise functionally associated with an initialization module, which initialization module may be integral or otherwise functionally associated with an operating condition monitoring module which provides information to the initialization module about environmental and operational conditions (e.g. outdoors, indoors, residential, commercial, etc.) within which the system is operating when initialized. According to embodiments of the present invention, upon system initialization or upon a change occurring in an environmental/operational condition relating to a coverage area monitored by the system, deployment of one or more agent applications on one or more computational/processing platforms associated with the system may be triggered. Agent application deployment may be triggered and or directed by the initialization module upon system initialization in accordance with stored and/or user provided system configuration instructions. Initial agent application deployment may be performed by the deployment controller in accordance with instructions provided by the initialization module.

Initial agent application deployment triggered by the initialization module upon system initialization may be performed in accordance with system configuration data (instructions) preprogramed or otherwise provided by a user and or stored within a configuration data storage integral or otherwise functionally associated with the system. The initialization module or the deployment controller may factor environmental and operational condition information provided by an operating condition monitoring module when selecting agent applications templates for deploying corresponding agent applications. The initialization module or the deployment controller may factor environmental and operational condition information provided by the operating condition monitoring module when configuring agent applications being deployed. Initial agent application deployment according to embodiments of the present invention may include: (a) reading system configuration instructions and or self-registration information from connected sensor devices in order to select agent template types corresponding to intended coverage areas, types and scope, (b) factoring environmental and operational condition information to select specific agent templates for deployment and or to select configuration settings for agent application to be deployed based on selected templates, and (c) following deployment instructions associated with each selected template, as constrained by the system's physical configurations (i.e. processing platform resources, network addresses, process ID's, etc.), to properly install and interconnect each selected template's corresponding agent application.

Once deployed, a given agent application's configuration may be modified due to: (a) machine learning refinement of the given agent application's configuration based on operational feedback, (b) a detected change in the environment or other condition relating to a coverage area for which the given agent application was instanced, and or (c) the addition of another agent application to the system whose resource dependencies intersect, directly or indirectly, with those of the given agent application. An operating condition monitoring module may continue monitoring environments and or other conditions associated with coverage areas of the system and may signal an agent application configuration controller of the system, which may integral or otherwise functionally associated with the agent deployment controller, when a change in a monitored environment and or other condition has occurred. In response to the received signal, the configuration controller may adjust a specific agent application's configuration and/or replace the specific agent application with another agent application altogether, either with a new configuration or with a new agent application more suitable to the environment or condition indicated by the monitoring module.

Agent application resource allocation, resource access control and interconnections with other agent application may be reconfigured for deployed agent applications, such as for example when a new agent application, requiring interconnection to an existing agent application, is deployed. Accordingly, an agent deployment controller according to embodiments may also provide agent application management functions and may be referred to as an agent management controller. Upon deployment of an additional agent application within the system according to embodiments of the present invention, either due to a user instruction, the addition of new sensors to the system and or due to machine learning directed adaptation of one or more components of the system, the configuration controller may respond by adjusting one or more already running agent applications' configurations and/or replacing one or more running agent applications with other agent applications altogether, in order to accommodate for the new additional agent application's respective resource requirements and dependencies.

A situation assessment system according to embodiments of the present invention may include or be otherwise functionally associated with machine learning mechanism for iteratively improving the system's performance within the system's operational environment. According to some embodiments, during system operation, feedback from a first agent application may be used to refine a configuration setting of a second agent application. According to further embodiments, collected information such as characteristics of specific entities or persons regularly appearing within a coverage (e.g. entity visual attributes, entity motion dynamics, personality attributes, etc.) may be collected and stored within one or more coverage area specific data stores which may then be used to focus and improve performance, by speeding up convergence to a decision, of one or more monitoring agent applications of the system. Yet a further machine learning mechanism included or otherwise functionally associated with an assessment system according to embodiments of the present invention may be provided by a sandbox, platform or virtual environment of evolving neural networks used by one or more of the agent applications for sensor feed feature detection, feature extraction, pattern detection and or prediction.

A situational assessment system according to some embodiments of the present invention may include, access and or otherwise utilize a pool of agent application templates of varying types, each of which template may be used to instance or deploy a corresponding agent application of the same type. Template and corresponding agent application types according to embodiments of the present invention may fall into one out of several template/agent type categories. Some agent application templates may be of a type belonging to the “monitoring category” or of a “monitoring agent type.” An agent application instanced based on an agent template within the monitoring agent category may generally function to receive, analyze and record sensor feed data indicative of some location specific condition or event. Agent applications instanced from templates of a type in the monitoring category may directly receive and process real-time sensor output feeds, such as video feeds, audio feeds, temperature feeds, etc.

One example of an agent template and corresponding agent application pair of a type within the monitoring category is a template/agent application of the video feed feature extraction type. For a template/agent type within the monitoring category, the agent application during deployment may be interconnected to one or more video feeds from each of one or more coverage areas. Similarly, an agent application of an audio feed feature extraction type is also a monitoring agent type and may be interconnected to one or more audio feeds from each of one or more coverage areas of the system. Coverage area characterization data, from sensors focused on a coverage area or location, received and used by agent applications of a type in the monitoring category may include video feeds, audio feeds, temperature reading feeds, pressure reading feeds, outputs from motion sensors, thermal imaging output and/or any other scene characterization data type known today or to be devised or discovered in the future.

According to further embodiments, agent applications instanced from templates of a type in the monitoring category may also receive and process real-time outputs of one or more other monitoring agent applications, wherein each the one or more other monitoring agents may receive a different sensor output feed of the same or of differing types. These monitoring agent applications may receive output from one or more other agent applications and may perform further monitor related processing of the received data and/or may perform sensor fusion type of processing for outputs from two or more monitoring agents with the same or related coverage areas.

Output of monitoring agent applications may be stored and or passed to agent applications of a type instanced from corresponding templates of a type within a “characterization” category, Data extracted from sensor feeds by one or more agent applications instanced from templates of types in the monitoring category may be characterized by each of one or more agent applications instanced based on a template of a type within the “characterization” category, Examples of agent applications based on templates with the characterization category may include: (a) entity presence detection agents, (b) entity appearance characterization agents; (c) entity identification agents; (d) entity activity (e.g. movements and utterances) characterization agents; (e) entity psychological attribute characterization agent; (f) environment characterization agents, (g) soundscape characterization agents, etc.

Each time an agent application based on a template within the characterization category is deployed within a system according to embodiments of the present invention, the deployment controller may communicatively interconnect the newly instanced agent application to relevant monitoring agent outputs. The data interconnections may be direct or through a shared data store to which one or more monitoring agent application(s) write and or from which one or more characterization agents reads. Deployment of such characterization category agent applications may also include interconnection of the agent application's output to one or more data stores and or to one or more higher level agent applications, such as, for example one or more agent applications based on a template type within a “spatiotemporal pattern detection” category, and or one or more agent applications whose template type is within an “alert generator” category.

Some agent applications may be based on agent templates of a type within the “spatiotemporal pattern detection” category. Agent applications based on agent types in the pattern spatiotemporal pattern detection category may continuously or intermittently read through data stores containing location specific parameter and event records originating from sensors feeds relating to a given coverage area or from a given location (collectively space) in order to identify patterns of movements through the space (heat maps), patterns of recurring events within the space, identities of entities frequenting the space, patterns of behavior of entities frequenting the space, etc. According to some embodiments, identified spatiotemporal patterns may be recorded or stored and serve as a basis for predicting or establishing expectation with regard to future events and/or parameters to occur within the given space. Recorded spatiotemporal patterns may serve as a reference by one or more agent applications with are of type within the “alert generator” category.

According to further embodiments, the system may include corresponding, complimentary or matched agent types from different categories working in concert. For example, one agent type in the monitoring category may be a presence detection and logging agent type, wherein an agent application based on this agent type may receive video sensor data from a covered location, and may identify and log the appearance and/or movements of persons appearing within the covered location. A corresponding or matched agent type in the pattern detection category may be, for example, a heatmap generator agent type, wherein an agent application based on this agent type may generate one or more heatmaps for a given location based on monitored presence and/or movement records generated by one or more agent applications of a presence detection type. Furthermore, one or more agent applications based on templates of types within an “alert notification” category may receive outputs from one or more matched agent applications of types within the monitoring category and or from one or more outputs from one or more corresponding/matched agent applications of types within the characterization category, and may compare these output to recorded patterns in order to gauge, assess or otherwise detect a condition for which an alert notification may need to be issued by the system.

According to further embodiments, a category of template types and corresponding agent application types may be part of an “alert notification” category of types. System agent applications within this type category may generate system alert notifications or alerts when a corresponding matching monitoring agent application detects from a sensor feed an event or another parameter which is “of interest.” An event or parameter may be deemed of interest if it: (a) is defined by some fixed system rule, (b) violates some fixed system rule, and (c) deviates from an expected pattern recorded by system for a given coverage area, location or space. System agent applications of a type within the alert notification category may generate system notifications or alerts due to a detected event deviating from an expected event or parameter predicted by a system agent of a type within the pattern detection category. System agent applications of a type within the alert notification category may also generate system notifications or alerts due to an absence of detection of an expected event or parameter predicted by a system agent of a type within the pattern detection category.

A system according to further embodiments of the present invention may utilize neural networks for sensor feed feature classification, image feature extraction, two-dimensional pattern detection, spatiotemporal pattern detection and/or prediction. Accordingly, there may be provided a neural network manager adapted to synthesize, instance and/or modify one or more derived neural network structures based on one or more neural network templates and responsive to one or more sensor based event detections within the coverage area of the system. The neural networks maybe integral with or otherwise accessible by agent applications utilizing their respective functionality.

According to some embodiments, instructions for a neural network's deployments by the manager may be stored within a respective neural network template, and or may be stored or associated with an agent application template corresponding to which the neural network.

Neural networks according to embodiments of the present invention may be adapted to convert a set of sensor outputs, raw or conditioned, into a classification output, for example an output indicating the detection of an entity type, a specific entity, an event, a situation, and/or a condition. According to some embodiments of the present invention, the system may include a set of reference neural network structures, which reference neural network structures may be used during cold start operation of the system and for providing templates for generating or deriving scene specific or coverage area specific neural networks. Deriving a scene or coverage area specific neural network of a given scene or area may include duplicating a reference network and then iteratively training the neural network copy using data specifically detected from the given scene or area. A scene specific or coverage area specific neural network may also be generated by constructing or instancing a blank/untrained neural network structure and proceeding to train the blank network using data specifically detected from the given scene or area.

According to embodiments, the neural network manager may produce and may update each of a set of neural networks associated with corresponding monitoring category agent application for processing data generated by one or more sensors focused on a scene being covered by the respective agent applications. The processing platform according to embodiments of the present invention may include or be functionally associated with a neural network operating or hosting space within which one or a cluster of dynamic neural networks may be deployed and operated. Within a neural network operating space according to embodiments of the present invention, and optionally using a neural network manager with access to a pool of neural network templates, neural networks for sensor feed processing may be created, modified or removed. Additionally, interconnections between neural networks within the cluster may be created, modified and removed for purposes of multifactor processing. Accordingly, the present invention may provide for a self-training and/or self-learning scene-sensor-feed processing system adapted to detect, identify and optionally respond to entities, events, situations and conditions associated with an agent application coverage area.

Reference neural networks according to embodiments may be adapted and/or used to classify generic entity types, action types and/or conditions. Scene/area specific neural networks may be adapted to classify specific entities native to, or otherwise associated with, the scene or coverage area. A scene or coverage area specific neural network may also be adapted to output an indicator associated with detection of an event or condition specific to the scene or coverage area, wherein these scene/area specific neural network may be derived from a reference network or may be generated from a blank neural network structure using algorithm driven training.

During operation of a situational assessment system according to embodiments of the present invention, some portion or version of output data from one or more coverage area sensors may be provided to a corresponding neural network for entity type classification or grouping. Depending upon a classification output from a first neural network, the same or another portion of the sensor output may be applied as input to a dynamically selected second neural network. For example, if a first neural network adapted to classify entity types from a video feed data generates an output indicating the presence of a child entity type within the video feed data, the video feed data may be forwarded to a second neural network adapted to classify movement types specific to a child.

The digital processing platform of a situational assessment system according to embodiments of the present invention may include neural network training modules integral or otherwise functionally associated with the neural network manager(s). The neural network training modules may generate training data, for training a new or derived neural network, from coverage area sensor outputs and/or from alternative sources, including data repositories accessible through data communication networks such as the Internet. Neural network training data may be based on a combination of: (1) coverage area sensor outputs, and (2) outputs from algorithmically based classifiers or feature extractors processing the coverage area sensor outputs. Alternatively, the training data may be based on a combination of: (1) coverage area sensor outputs, and (2) outputs from other, optionally remotely located, neural networks also receiving the coverage area sensor outputs. The neural network manager may use the training data when adjusting an existing neural network, deriving a neural network from an existing network and/or when training a completely new neural network.

Neural networks and neural network clusters according to embodiments of the present invention may be deployed and interconnected with agent application of a type in each of the type categories: (a) monitoring, (b) characterizing, (c) spatiotemporal pattern detection, and (d) alert notification.

### BRIEF DESCRIPTION OF THE FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a system level functional block diagram of an exemplary situational assessment system according to embodiments of the present invention;

FIG. 2A is a diagrammatic illustration showing various types of agent application templates available in accordance with exemplary embodiments of the present invention, wherein the templates are organized by respective categories of template types;

FIG. 2B is a radial diagram illustrating relationships between agent application instanced from agent application templates of some of the different categories and their respective relationship to system data feeds;

FIG. 3A shows a functional block diagram of a first specific system configuration for a first specific location; and

FIG. 3B shows a functional block diagram of a second specific system configuration for a second specific location.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE FIGURES

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like. Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), any composition and/or architecture of semiconductor based Non-Volatile Memory (NVM), any composition and/or architecture of biologically based Non-Volatile Memory (NVM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other functionally suitable components may be used.

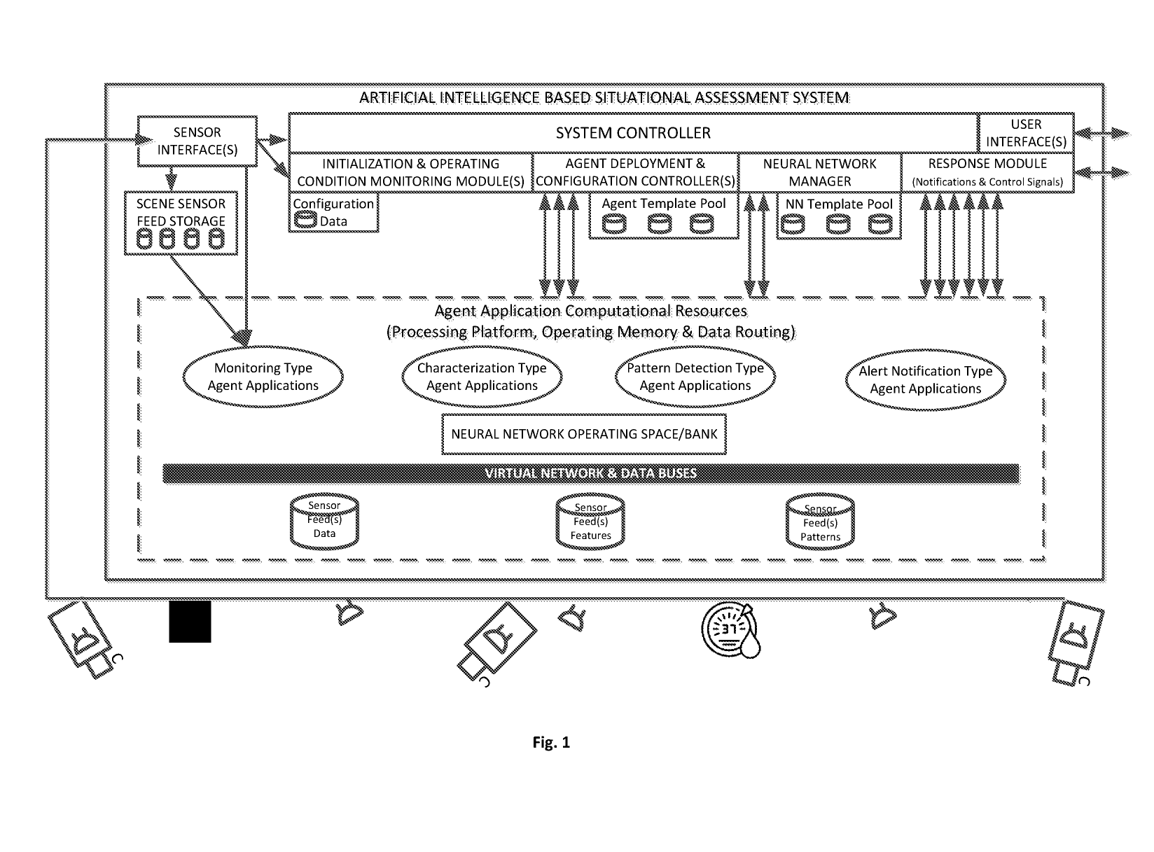

Embodiments of the present invention include methods, structures, circuits, devices, systems and functionally associated computer executable code for artificial intelligence based situational assessment. Turning now to FIG. 1, there is shown a location specific situational assessment system according to embodiments of the present invention. The system comprises a sensor interface to receive sensing related data from each of one or more location specific sensors directed towards and acquiring information from respective coverage areas of a specific location or specific set of locations being covered by the system. An agent application deployment controller, responsive to location specific information embedded within data received from said one or more sensors, selects from a pool of agent application templates an agent application template corresponding to the location specific information. The deployment controlled also deploys within a processing platform of said system, with computing and other system resources, an agent application based on the selected agent application template. Agent application deployment within the processing platform includes establishing connectivity between the agent application being deployed and one or more system resources for supporting an intended operation of the agent application. The system resources with which connectivity is established may be selected from the group consisting of: (a) one or more sensor feeds; (b) one or more other agent applications running on the computing platform; (c) read access to one or more specific system data storage areas or data stores; (d) write access to one or more specific system data storage areas or data stores; and (e) one or more neural networks.

According to embodiments of the present invention, access to one or more of the systems resources may be secured. In situations where sensor devices providing sensor feeds and processing resources are located in different places, such as when agent applications run on cloud processing platforms to assess situations based on home or business surveillance video camera output, securing sensor feeds with encryption on the feed level may be desirable. Therefore, in order to establish connectivity between the agent application being deployed and one or more system resources with encrypted or otherwise secured access, may require: (a) encryption key management; (b) providing an encryption key to the to be deployed agent application; (c) providing authentication credentials to the to be deployed agent application; (d) providing an encryption key to the resources to be accessed; (e) providing authentication credentials to the resources to be accessed.

According to embodiments of the present invention, some agent applications may be deployed upon system initiation, substantially automatically. The system includes an initialization module to, upon initialization of said system, cause said deployment controller to deploy one or more agent applications by default. The initialization module may include basic sensor feed type identification functionality, and may cause deployment of agent applications whose functions include sensor feed access and monitoring to support automatic system self-configuration. According to embodiments where the systems has been configured and is being initiated as a part of a system restart or reboot, the initiation module may cause the deployment module to deploy agent applications in accordance to configuration instructions stored in a system configuration file or con data structure.

According to embodiments, the system may include a condition monitoring module to monitor one or more sensors feeds and to trigger and or instruct the deployment controller to deploy one or more specific agent applications suited for a coverage area associated with the monitored one or more sensor feeds based on operating condition information derived from data with the monitored sensor feeds. The monitoring module may include basic sensor feed type identification and basic sensor feed data feature characterization functionality to: (a) assess which kinds of sensor devices are providing which sensors feeds, and (b) detect data features within a sensor feed indicating an operational environment (e.g. a residence, an office, outdoors, restaurant, industrial space, etc.) within the coverage area of the sensor device.

According to embodiments, the pool of agent applications templates from which agent application templates are selected includes two or more templates of differing template types, wherein each template type is associated with a set of one or more functions performed by an agent application based on the template type. Agent functions may include base data feed monitoring—video, audio, temperature, etc. Agent applications functions may generally groups as into monitoring, feature extraction, feature characterization, pattern recognition and/or alert notification. More specific grouping of agent functions is by sensor feed data types, and even more specific grouping is by sensor type combination, as some agent applications may process data from two or more sensors of different types. Each of two or more agent application templates may produce agent applications with the same function, such as for example extracting features from the same combination of data feeds, but the produced/instanced agent applications may be optimized for processing sensor feed data originating in differing operational environments.

The situational assessment system according to claim 6, wherein two or more templates of the same template type are each configured to produce agent applications performing the same or similar functions but optimized for operation within different operational conditions associated with different coverage areas.

At least one of the agent application templates in the pool may include or is associated with deployment instructions for use by the deployment controller to deploy an agent application based on the at least one template. The deployment instructions may provide the controller with information as to which types of data feeds and or other resources are needed for the agent application to be deployed using the template. The instructions may be general or global and the deployment controller may localize the instructions to actual current resources present in the system at the time of deployment.

A situational assessment system according to embodiments of the present invention may include a neural network manager, and at least one of the agent application templates may include or is associated with agent deployment instructions which include instructions for interconnection of an agent application to be instance from the template with one or more neural networks either running or to be built. Deployment instructions including instructions for interconnection to a neural network may trigger the neural network manager to: (a) instance a new neural network based on a neural network template; (b) interconnect the respective agent application to an existing agent application; and or (c) modify an existing neural network for a modified mode of operation. The neural network manager may deploy each of the one or more new neural networks pretrained for a specific respective task based on information contained in respective corresponding neural network templates. The neural network manager may modify an existing neural network with new weights and new threshold values.

The situational assessment system according embodiments includes a neural network operating environment or bank where one or more instanced neural networks may operate to receive sensor data from one or more sensor feeds or from one or more agent applications. The neural network manager is adapted to instance, modify, interconnect or remove a neural network from said neural network operating environment or bank. The neural network manager is further adapted to modify a neural network by adjusting weights and threshold values of an instanced neural networks based on operational feedback during operation of said system. Operational feedback includes user responses to issued alerts, agent application validation of neural network output, and or any other neural network training method known today or to be devised in the future.

The situational assessment system according embodiments may include an agent application deployment controller which also manages deployed agent applications and reconfigures or replaces deployed agent applications based on: (a) detected changes in an operational condition within one or more coverage areas within the location being monitored by said system; (b) operational feedback during operation of said system. Deployed agent application reconfiguration is intended and adapted to optimize agent application operation for one or more coverage areas of said agent application by updating location specific data within a data store of the system used by said agent application. The location specific data includes: (a) location specific entity characterization (appearance, behavioral, emotional) information; (b) location specific entity role information; (c) location specific entity identification information; and (d) location specific entity motion dynamics information.

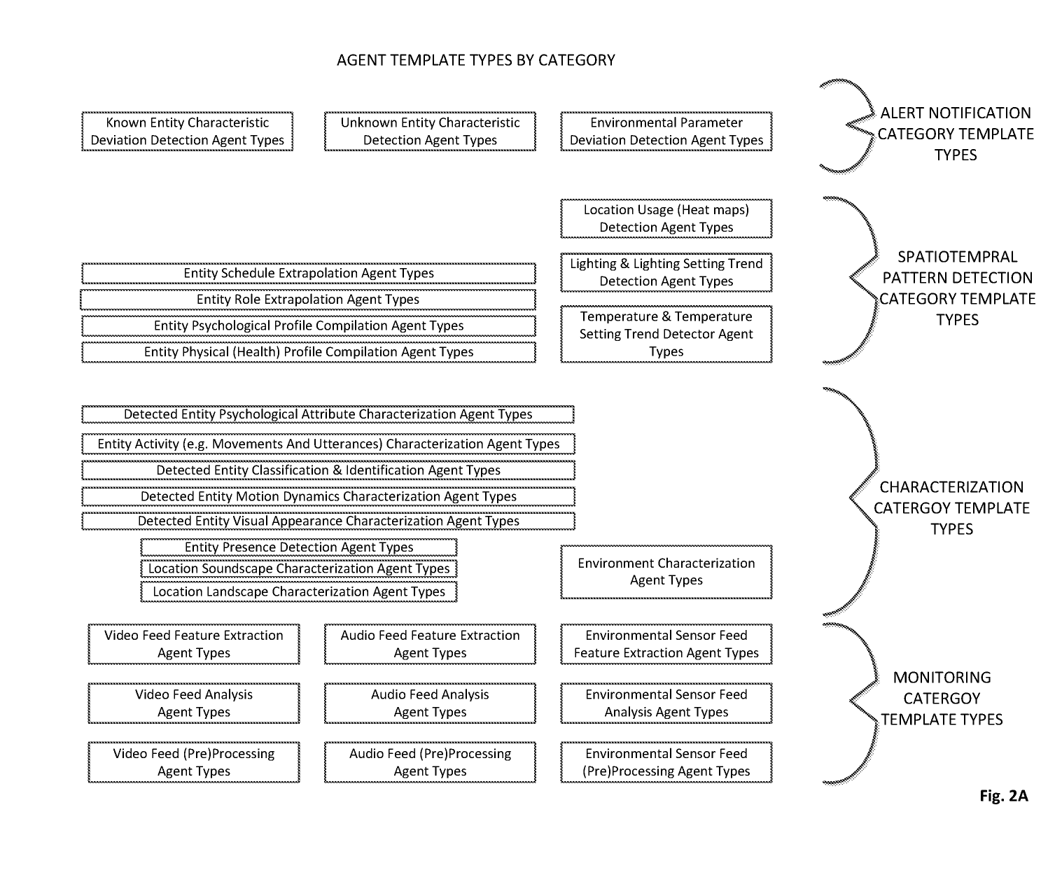

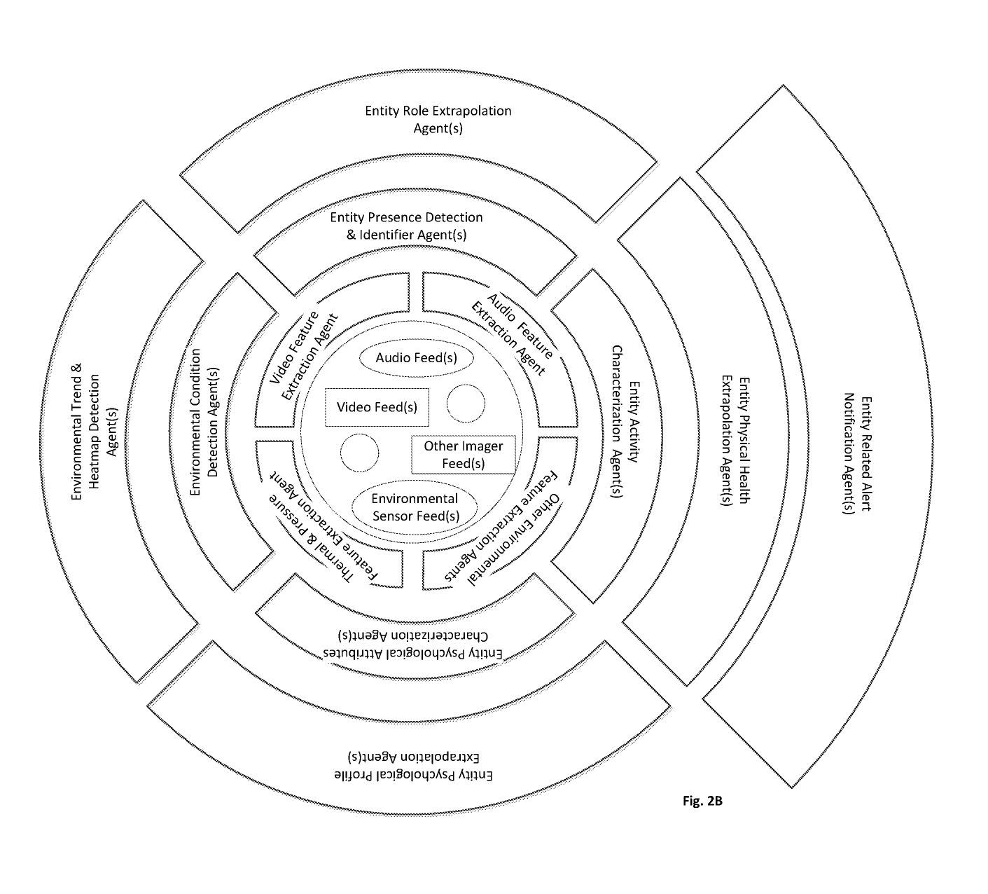

Turning now to FIG. 2A, there is shown an illustration type listing of exemplary agent applications template types grouped into categories: (a) monitoring, (b) feature extraction/characterization, (c) pattern recognition and (d) alert notification. The names used for the template types are exemplary and the list is neither restrictive nor complete. Various other agent application templates may be devised and utilized in accordance with embodiments of the present invention.

Turning now to FIG. 2B, there is shown a concentric type illustration listing of agent applications operating with a processing environment of a system according to embodiments of the present invention. The illustration depicts hierarchical relationships between exemplary agent applications, instanced from templates from different categories, with each other and with system resources like sensor feeds. Monitoring type applications are closest to the sensor feeds and lowest in the hierarchical such that they only have access to the sensor feed data. The alert notification type agents are highest in the hierarchy and have regulated access to data from the feeds up and from other agent applications, up to the spatiotemporal pattern recognition type agent applications.

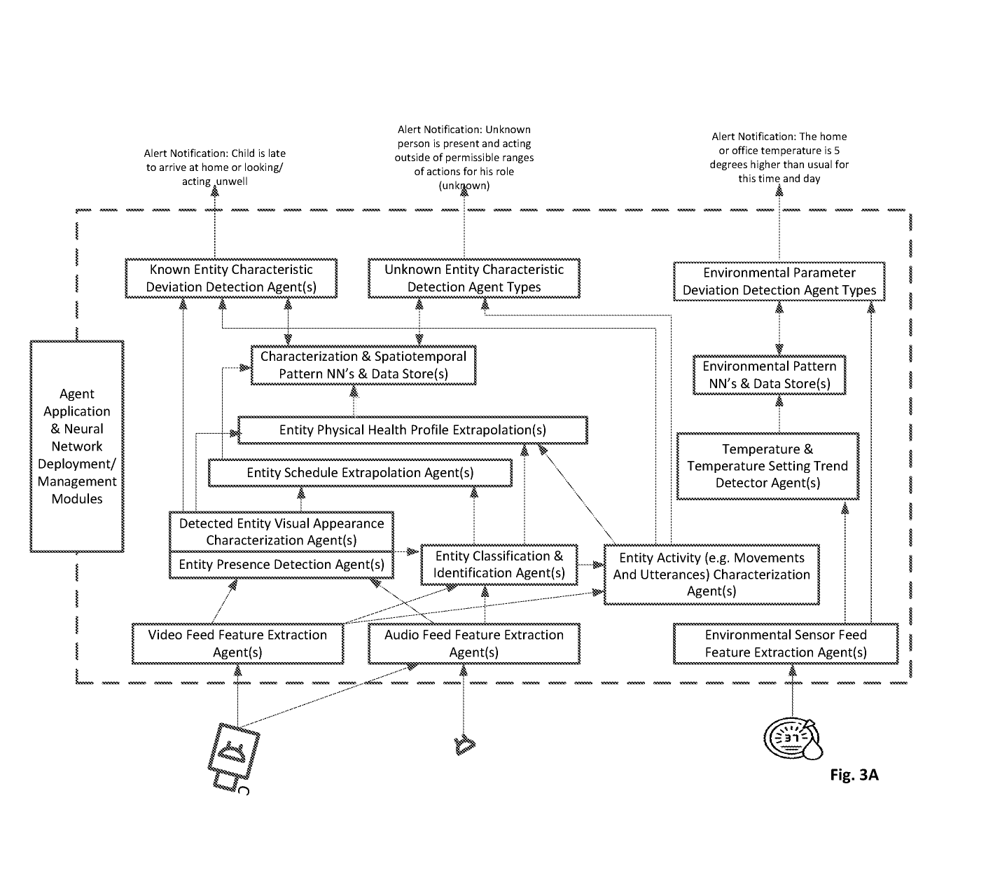

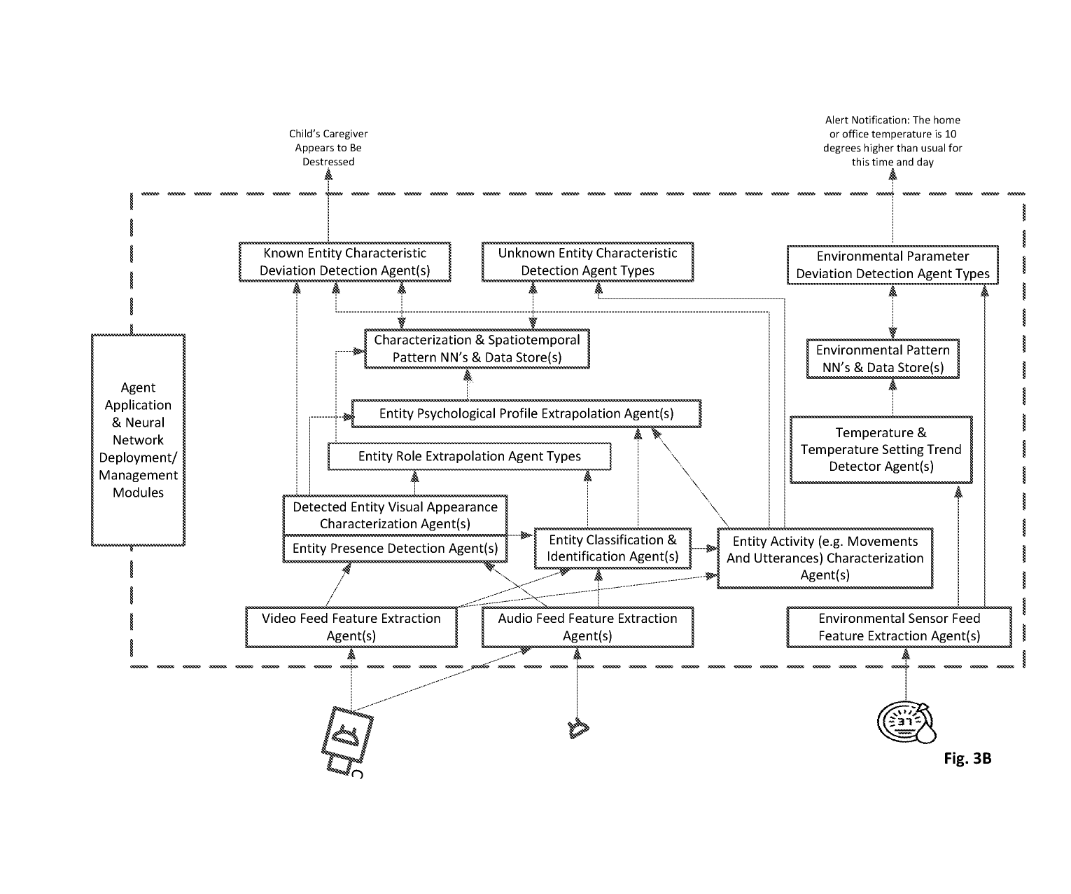

Turning now to FIG. 3A, there is shown one functional block diagram of a set of agent applications running within an operating environment of a system according to embodiments of the present invention. FIG. 3B shows another functional block diagram of a modifier set of agent applications running within an operating environment of a system according to other embodiments of the present invention.

Embodiments of the present invention include distributed independent processing agents of types, functions, within different categories. Without detracting from the organization of agent applications and agent application templates described and illustrated thus far, agent applications according to embodiments of the present invention may perform various tasks or combinations of tasks. An agent application according to embodiments of the present invention may perform tasks such as: (a) static feature extraction from one or more video-feeds; (b) scene background mapping; (c) reference frame generating within a coverage area of a sensor; (d) entity detection (basic detection/extraction/segmentation of entities appearing in the video feed); (e) entity type classification (e.g. person, dog, chair, etc.); (f) entity appearance characterization; (g) entity motion dynamics detection and characterization; and (h) entity identifier (specific person or thing); (i) entity action/activity/utterance detection and characterization.

Some monitoring and or characterization type agent applications according to embodiments perform tasks relating to environmental condition detection including: (a) lighting levels and type; (b) ambient and set temperature; and (c) air pressure.

Monitoring category agent applications may store and generate logs of detected and or characterized and or classified features, entities and or events from sensor feeds. Stored logs may be used by higher level pattern detection agent applications to extrapolate spatiotemporal patterns and or predictive models for a coverage or location. Alert notification agent applications may compare currently detected event to stored predictive models in order to assess where an alert condition exists. Alert Condition Assessment may occur when: (a) a detected condition/event violates a predefined condition/event rule; (b) a detected condition/event differs with an expected condition or event expectation based on a spatiotemporal pattern compiled for the location.

The processes and displays presented herein are not inherently related to any particular computer, device, system or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Functions, operations, components and/or features described herein with reference to one or more embodiments, may be combined or otherwise utilized with one or more other functions, operations, components and/or features described herein with reference to one or more other embodiments, or vice versa. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A location specific situational assessment system comprising:
a sensor interface to receive sensing related data from each of one or more location specific sensors directed towards and acquiring information from a respective coverage area of a specific location;
an agent application deployment controller to, responsive to location specific information embedded within data received from said one or more sensors, select from a pool of agent application templates an agent application template corresponding to the location specific information and to deploy within a processing platform of said system an agent application based on said selected agent application template; and
wherein agent application deployment within said processing platform includes establishing connectivity between the agent application being deployed and one or more system resources.

2. The situational assessment system according to claim 1, wherein said system resources with which connectivity is established may be selected from the group consisting of: (a) a sensor feed; (b) another agent applications running on the computing platform; (c) system data storage; and (d) a neural network.

3. The situational assessment system according to claim 2, wherein access to one or more of said systems resources is secured and establishing connectivity between the agent application being deployed and one or more system resources includes: (a) encryption key management; (b) providing an encryption key to the to be deployed agent application; (c) providing authentication credentials to the to be deployed agent application; (d) providing an encryption key to the resources to be accessed; (e) providing authentication credentials to the resources to be accessed.

4. The situational assessment system according to claim 1, further comprising an initialization module to, upon initialization of said system, cause said deployment controller to deploy one or more agent applications by default.

5. The situational assessment system according to claim 4, further comprising a condition monitoring module to monitor one or more sensors feeds and to trigger said deployment controller to deploy one or more specific agent applications suited for a coverage area associated with the monitored one or more sensor feeds based on operating condition information derived from data with the monitored sensor feeds.

6. The situational assessment system according to claim 1, wherein said pool of agent applications templates includes two or more templates of differing template types, wherein each template type is associated with a set of one or more functions performed by an agent application based on the template type.

7. The situational assessment system according to claim 6, wherein two or more templates of the same template type are each configured to produce agent applications performing the same or similar functions but optimized for operation within different operational conditions associated with different coverage areas.

8. The situational assessment system according to claim 6, wherein at least one of the agent application templates includes or is associated with deployment instructions for use by said deployment controller to deploy an agent application based on the at least one template.

9. The situational assessment system according to claim 6, further comprising a neural network manager and wherein at least one of the agent application templates includes or is associated with agent deployment instructions which include instructions for interconnection of an agent application with one or more neural networks.

10. The situational assessment system according to claim 9, wherein deployment instructions including instructions for interconnection to a neural network trigger said neural network manager to: (a) instance a new neural network based on a neural network template; (b) interconnect the respective agent application to an existing agent application; and (c) modify an existing neural network.

11. The situational assessment system according to claim 10, wherein said neural network manager deploys each of the one or more new neural networks pretrained for a specific respective task based on information contained in respective corresponding neural network templates.

12. The situational assessment system according to claim 11, further comprising a neural network operating environment or bank where one or more instanced neural networks operates to receive sensor data from one or more sensor feeds or from one or more agent applications.

13. The situational assessment system according to claim 12, wherein said neural network manager is adapted to instance, modify, interconnect or remove a neural network from said neural network operating environment or bank.

14. The situational assessment system according to claim 13, wherein said neural network manager is further adapted to adjust weights and threshold values of an instanced neural networks based on operational feedback during operation of said system.

15. The situational assessment system according to claim 5, wherein said agent application deployment controller also manages deployed agent applications and reconfigures or replaces deployed agent applications based on: (a) detected changes in an operational condition within one or more coverage areas within the location being monitored by said system; (b) operational feedback during operation of said system.

16. The situational assessment system according to claim 15, wherein deployed agent application reconfiguration optimizes agent application operation for one or more coverage areas of said agent application by updating location specific data within a data store of the system accesses by said agent application.

17. The situational assessment system according to claim 16, wherein the location specific data includes: (a) location specific entity characterization information; (b) location specific entity role information; (c) location specific entity identification information; and (d) location specific entity dynamics information.

18. A method or providing location specific situational assessment comprising:
receiving data feeds with sensing related data from each of one or more location specific sensors directed towards and acquiring information from a respective coverage area of a specific location;
responsive to location specific information embedded within data received from said one or more sensors, programmatically selecting from a pool of agent application templates an agent application template corresponding to the location specific information and deploying within a processing platform an agent application based on said selected agent application template, wherein the agent application deployment within the processing platform includes establishing connectivity between the agent application being deployed and one or more system resources.

19. The method according to claim 18, wherein the system resources with which connectivity is established may be selected from the group consisting of: (a) a sensor feed; (b) another agent applications running on the computing platform; (c) system data storage; and (d) a neural network.

20. The method according to claim 19, wherein access to one or more of said systems resources is secured and establishing connectivity between the agent application being deployed and one or more system resources includes: (a) encryption key management; (b) providing an encryption key to the to be deployed agent application; (c) providing authentication credentials to the to be deployed agent application; (d) providing an encryption key to the resources to be accessed; (e) providing authentication credentials to the resources to be accessed.

21. The method according to claim 20, further including monitor one or more sensors feeds and triggering deployment of one or more specific agent applications suited for a coverage area associated with the monitored one or more sensor feeds based on operating condition information derived from data with the monitored sensor feeds.

22. The method according to claim 21, wherein said pool of agent applications templates includes two or more templates of differing template types, wherein each template type is associated with a set of one or more functions performed by an agent application based on the template type.

23. The method according to claim 22, wherein two or more templates of the same template type are each configured to produce agent applications performing the same or similar functions within different operational conditions associated with different coverage areas.
